(19) United States
(12) Patent Application Publication
(10) Pub. No.: US 2010/0026794 A1
(43) Pub. Date: Feb. 4, 2010

(54) Method, System and Apparatus for Multiuser Display of Frame-Sequential Images

(76) Inventor: Sin-Min Chang, Shelton, CT (US)

Correspondence Address: GORDON & JACOBSON, P.C., 60 LONG RIDGE ROAD, SUITE 407, STAMFORD, CT, 06902, US

(21) Appl. No.: 12/183,000

(22) Filed: Jul. 30, 2008

(51) Int. Cl. H04N 13/04

(52) U.S. Cl. 348/56

(57) ABSTRACT

A method for stereoscopic viewing in a multiuser environment (and corresponding system and apparatus therein) generates at least one signal representing a sequence of image triplets including a left perspective image, a right perspective image, and a transformation image. The signal is processed for displaying the sequence of image triplets in a frame-sequential manner. A synchronization signal is communicated to shutter glasses for blocking the viewing of the transformation image. The transformation image is adapted to reduce discomfort when viewing the stereoscopic images of the image triplets without blocking of the transformation image by the synchronized shutter glasses.

In another aspect, a cloaking image is displayed as part of a frame sequential stereoscopic image sequence (or a frame sequential non-stereoscopic image sequence) for privacy purposes. A synchronization signal is communicated to shutter glasses for blocking the viewing of the cloaking image.

### BACKGROUND OF THE INVENTION

1. Field of the Invention

This invention relates generally to image generation and display methodologies and systems. More particularly, this invention relates to page flipping stereoscopic image generation and display methodologies and systems as well as apparatus used therein.

2. State of the Art

Stereoscopic image generation and display systems display two perspective images in such a way that each eye of the observer sees only one of the two images. There are many systems in existence that provide this capability through various methods. One of these methods is commonly referred to as “page flipping” or frame-sequential stereo image display. In such methods, left and right perspective images are time-division multiplexed and thus displayed during different display periods (i.e., left and right perspective image display periods). Stereoscopic glasses (e.g., shutter-type or polarization-type glasses) are used to ensure that the left perspective images are presented to the left eye during the left perspective image display periods and that the right perspective images are presented to the right eye during the right perspective image display periods.

Autostereoscopic systems have been developed that utilize optics (e.g., lenticular systems, parallax barrier, mirror systems, etc.) to present the left perspective images to the left eye and the right perspective images to the right eye without the need for glasses. Such systems are costly and suffer from various technical problems such as limited depth of field, low brightness, and constrained view regions (i.e., the observer(s) are required to be located in limited viewing area(s) relative to the display).

Page flipping stereoscopic image generated and display systems are typically realized with a cathode ray tube (CRT) display that is adapted to operate in a progressive scan mode that alternately displays a left perspective image and a right perspective image. Such systems provide adequate performance but are limited by their screen size and weight. Page flipping stereoscopic image generation and display methodologies have also been realized in DLP, PDP and active-matrix liquid-crystal display (LCD) panels. Such panels advantageously provide for increased screen size and significant reductions in weight.

In page flipping stereoscopic image display systems, viewers of the frame-sequential stereo images that are not wearing glasses for proper viewing of the left and right perspective images can experience visual discomfort that arises from the disparities between the left and right perspective images. Such discomfort can limit the acceptability of such systems for certain multiuser environments including public display environments allowing for the presence of unintended viewers.

### SUMMARY OF THE INVENTION

It is therefore an object of the invention to provide an improved page-flipping stereoscopic image generation and display methodology and system that is suitable for multiuser environments where one or more viewers of the frame-sequential stereo images are not wearing shutter glasses for proper viewing thereof.

It is yet another object of the invention to provide an improved image generation and display methodology and system that is suitable for multiuser environments where viewing of the frame-sequential stereo (and non-stereo) images can be made by private only to authorized viewers.

In accord with these objects, which will be discussed in detail below, an improved stereoscopic image generation and display methodology (and corresponding system and apparatus therein) generates at least one signal representing a sequence of image triplets including a left perspective image, a right perspective image, and a transformation image. The signal is processed for displaying the sequence of image triplets in a frame-sequential manner. A synchronization signal is communicated to shutter glasses for blocking the viewing of the transformation image of the sequence of image triplets. The transformation image is adapted to reduce discomfort when viewing the sequence of image triplets displayed in frame-sequential manner without blocking of the transformation image.

In another aspect of the invention, an image generation and display methodology (and corresponding system and apparatus therein) generates at least one signal representing a sequence of image n-tuples (where n=2 or 3) including a cloaking image. The signal is processed for displaying the sequence of image n-tuples in a frame-sequential manner. A synchronization signal is communicated to shutter glasses for blocking the viewing of the cloaking image of the sequence of image n-tuples. The cloaking image in combination with the other image(s) of the n-tuple synthesize a scene that hides or obfuscates the information contained in the other image(s) of the n-tuple when viewing the sequence of image n-tuples displayed in frame-sequential manner without blocking of the cloaking image. In the preferred embodiment, the clocking image of a given n-tuple is derived by applying a predetermined transformation operation to the color values of the corresponding pixel(s) of the other image(s) of the given n-tuple on a pixel-by-pixel basis. Alternatively, the transformation operation can be performed over corresponding neighboring pixel groups, e.g., neighboring 2×2 pixels, neighboring 3×3 pixels, neighboring 4×4 pixels, etc.

Additional objects and advantages of the invention will become apparent to those skilled in the art upon reference to the detailed description taken in conjunction with the provided figures.

### BRIEF DESCRIPTION OF THE DRAWINGS

FIG. 1 is a high level schematic diagram of a stereoscopic image generation and display system in which the present invention can be embodied.

FIG. 2 is a pictorial illustration of the frame-sequential images generated and displayed by the system of FIG. 1 in conjunction with the control of shutter glasses for proper viewing of the frame-sequential images displayed by the system of FIG. 1.

FIG. 3A is a functional block diagram of an exemplary active matrix liquid crystal display architecture that can be used to realize the display apparatus in which the present invention can be embodied.

FIG. 3B is a schematic diagram of an exemplary active pixel structure for the pixels of the active matrix liquid crystal display architecture of FIG. 3A.

FIGS. 4A-4D are schematic diagrams that illustrate the temporal relationship of the pixel clearing, loading and display operations for frame-sequential images in conjunction with the operation of shutter glasses worn by viewers of the images in accordance with the present invention.

### DETAILED DESCRIPTION

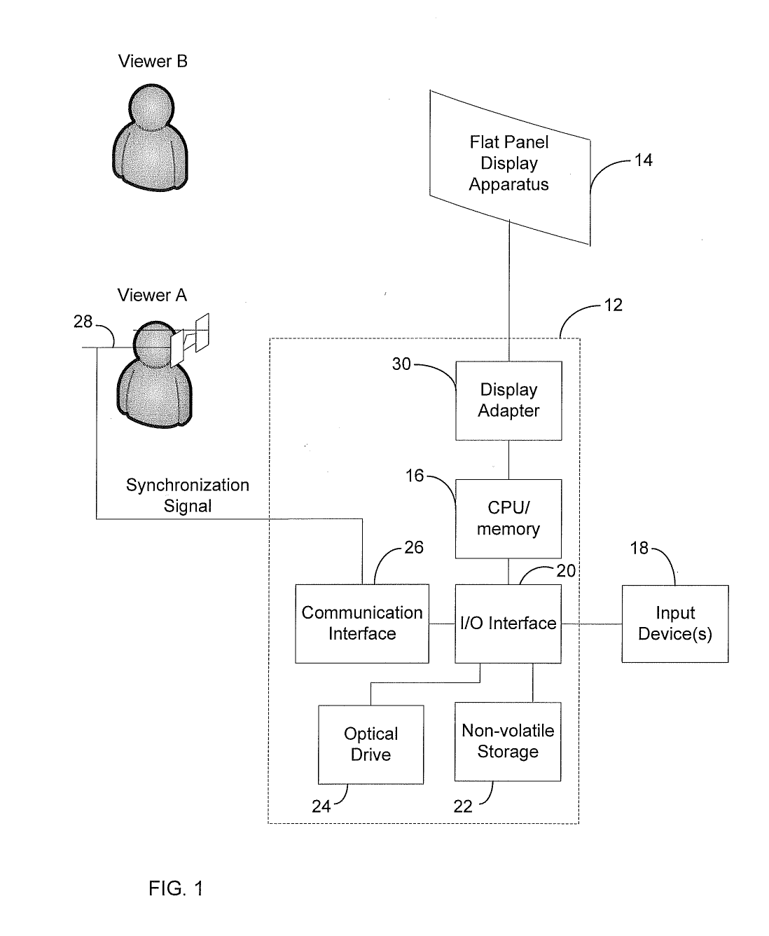

Turning now to FIG. 1, there is shown a high level schematic diagram of a stereoscopic image generation and display system in which the present invention can be embodied, including a front-end image generation apparatus 12 that interfaces to a flat panel display apparatus 14. The image generation apparatus 12 includes a processor platform 16 (e.g., a microprocessor and associated memory, typically realized by one or more volatile DRAM modules) that interfaces to one or more user input devices 18 (e.g. a button(s), keypad, keyboard, mouse, hand-held remote, etc.) via I/O interface circuitry 20. The interface circuitry 20 also preferably provides an interface between the processor platform 16 and non-volatile data storage 22 (e.g., a hard disk drive or solid state storage device), an optical drive 24 (e.g., a CDROM drive, DVD drive or Blu-Ray drive) and a communication interface 26, respectively. For simplicity of illustration, the I/O interface circuitry 20 is shown as single interface block; however, it can be hierarchical in organization employing multiple components as is well known in the arts. The communication interface 26 provides a communication link to shutter glasses 28 worn by viewers of the system. The communication link carries a synchronization signal that controls the operation of the shutter glasses 28 as described below in detail. The communication link can be a wired communication link (such as a wired USB link or wired Ethernet link) or a wireless communication link (such as a wireless 802.11a/b/n link, a Bluetooth link, a ZigBee link, or infra-red link) as is well known in the networking arts. It is also contemplated that the communications link that carries the synchronization signal for control of the operation of the shutter glasses 28 can be realized as part of the display adapter 30 or flat panel display 14 or other system component.

The image generation apparatus 12 includes software and/or firmware (e.g., an operating system and supporting program logic) that is persistently stored in the non-volatile storage 22 and loaded into the processor platform 16 for execution thereon.

The image generation apparatus 12 is adapted to persistently store in the non-volatile data storage 22 one or more video data files that represent a sequence of stereoscopic images. Alternatively, such video data files can be loaded into the system from optical drive 24 as is conventional. Typically, such video data files are stored in an encoded form (e.g., an MPEG format) for compression purposes. To support such video data files, the software and/or firmware (e.g., the operating system and supporting program logic) that is persistently stored in the non-volatile storage 22 includes routines for decoding the encoded video data file(s) to reconstruct the stereoscopic image sequence represented therein along with their corresponding audio track(s). Alternatively, such decoding can be carried out by the display adapter 30. The display adapter 30 renders the reconstructed stereoscopic image sequence in a digital format suitable for output to the flat panel display 14. Typically, such rendering involves two-dimensional scaling operations, filtering operations, etc. The stereoscopic image sequence generated by the display adapter 30 is output to the flat panel display apparatus 14 for display thereon.

Alternatively, the image generation apparatus 12 can be adapted to persistently store in the non-volatile data storage 22 one or more three-dimensional graphics data files that define objects contained in one or more three dimensional scenes. Alternatively, such three-dimensional graphics data files can be loaded into the system from optical drive 24 as is conventional. Typically, the data that defines the objects of the three-dimensional graphics data file(s) consists of coordinates in a local coordinate system and attributes (e.g., color, reflectance, texture) of primitives. The primitives are geometric entities such as a polygon, line or surface. Typically, the primitives are triangles defined by the coordinates of three vertices in the local coordinate system as well as transformation matrices used to transform the objects of the scene from the local coordinate system to a world coordinate system, and thus specify the position, orientation and scale of the triangles in a three-dimensional scene. To support such three-dimensional graphics data files, the display adapter 30 employs a three-dimensional rendering engine that is conventionally divided into two functional parts: geometry processing and rasterization. Geometry processing typically includes a modeling transformation, lighting calculations, a viewing transformation, a clipping function, and viewport mapping. The modeling transformation transforms the primitives from the local coordinate system to a world coordinate system. The lighting calculations evaluate an illumination model at various locations (e.g., once per primitive for constant shading, once per vertex for Gouraud shading, or once per pixel for Phong shading). The viewing transformation transforms the primitives in world coordinates to a 3D screen coordinate system (sometimes referred to as the normalized projection coordinate system). The clipping function determines the primitives (or portions of the primitives) that are within the viewing frustrum. And viewport mapping maps the coordinates of the clipped primitives to the normalized device coordinate system (sometimes referred to as the 2D device coordinate system). Rasterization is the process which converts the description of the clipped primitives generated during geometry processing into pixels for display. For stereoscopic viewing, the three-dimensional rendering is adapted to render the scene from two viewpoints that are offset from one another (e.g., a left-eye viewpoint and a right-eye viewpoint), which results in the generation of corresponding left-perspective and right-perspective images. Such left-perspective and right-perspective images are output by the display adapter 30 to the flat panel display apparatus 14 for display thereon.

The display adapter 30 preferably outputs a frame-sequential digital video signal that represents the stereoscopic image sequence. In the preferred embodiment, the frame-sequential digital video signal is formatted in accordance with the 24-bit RGBHVC (red, green, blue, horizontal sync, vertical sync, pixel clock) digital format. Other digital video formats can be used.

The image generation apparatus 12 can be realized by a personal computer or laptop computer, a set-top box that receives cable-based or satellite-based television signals, a video player (such as a DVD player or Blu-Ray Disc Player), a dedicated 3D gaming machine, or other suitable audio/video component.

The flat panel display apparatus 14 is preferably realized by a transmissive-type active-matrix liquid crystal pixel array. A backlight and rear polarizer injects polarized light from the rear into the transmissive pixels of the array. A front polarizer (not shown) is disposed between the transmissive pixels of the array and the viewer. Alternatively, the display apparatus 14 can be realized by other suitable display devices, such as LCD front-projection and rear-projection displays and variants thereof (i.e., LCOS projection displays and SXRD projection displays), Plasma display panels, DLP front-projection and rear-projection displays, OLED displays, CRT displays, or other suitable display devices.

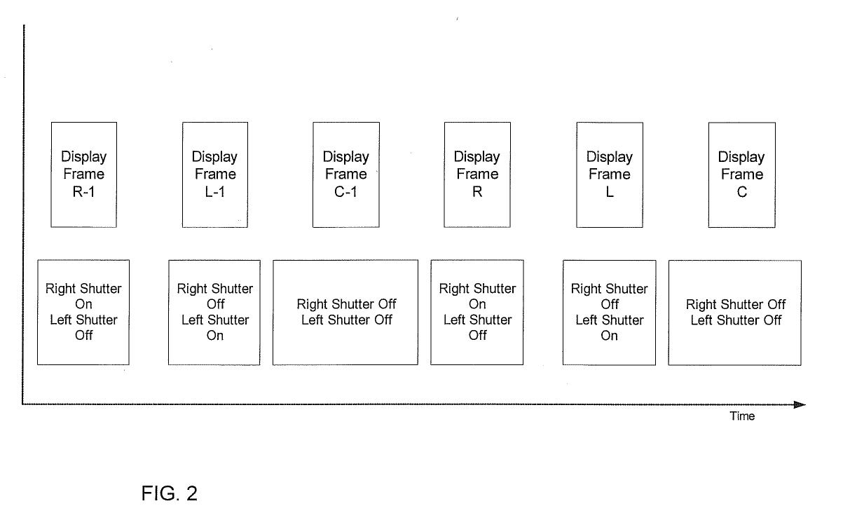

In accordance with the present invention, the stereoscopic image sequences stored and/or generated by the image generation apparatus 12 include a sequence of image triplets that include a right-perspective image, a left-perspective image, and a transformation image. The sequence of image triplets are displayed on the display apparatus 14. FIG. 2 illustrates an exemplary format for the image triplet sequence, which includes a right-perspective image (frame R-1) followed by a left-perspective image (frame L-1) followed by a transformation image (frame C-1). The synchronization signal is synchronized to the display periods of the image triplets and is adapted to control the shutter glasses 28 to turn ON and OFF the left and right shutters of the glasses 28 as shown in FIG. 2. More specifically, when the right-perspective image is displayed by the display apparatus 14, the shutter glasses 28 are controlled to turn ON (i.e., open) the right shutter and turn OFF (i.e., close) the left shutter. When the left-perspective image is displayed by the display apparatus 14, the shutter glasses 28 are controlled to turn OFF (i.e., closed) the right shutter and turn ON (i.e., open) the left shutter. When the transformation image is displayed by the display apparatus 14, the shutter glasses 28 are controlled to turn OFF (i.e., closed) both the left and right shutters. In this manner, the viewer(s) (one shown as viewer A) that wear the shutter glasses 28 view the right-perspective images only in his/her right eye and view the left-perspective image only in his/her left eye to provide the desired stereoscopic effect. The viewer(s) that wear the shutter glasses 28 are also blocked from viewing the transformation images and thus their stereoscopic viewing experience is not significantly degraded by the transformation images.

The transformation images are viewed by viewers that do not wear shutter glasses (e.g., one shown as viewer B in FIG. 1) and are defined in accordance with the corresponding right-perspective image (or the corresponding left-perspective image or both perspective images) such that discomfort is significantly reduced for those viewers that do not wear shutter glasses when viewing the sequence of image triplets on the display apparatus 14. It is contemplated that such effect can be accomplished by realizing the transformation image as the negative or complement color image of the right-perspective image or the left-perspective image of the image triplet. This configuration is useful because viewers/bystanders without proper shutter glasses will view a 2D image with some hue residuals instead of a super-imposed left and right eye image. For example, a pixel in the left-perspective image can be represented by:

L_{x,y}=(LRed(x,y),LGreen(x,y),LBlue(x,y)) (1)
where x,y represent a pixel of the image, and
LRed, LGreen, and LBlue represent the corresponding red, green, and blue component values of the pixel.
   Likewise, a pixel in the right-perspective image can be represented by:

R_{x,y}=(RRed(x,y),RGreen(x,y),RBlue(x,y)) (2)
where x,y represent a pixel of the image, and
RRed, RGreen, and RBlue represent the corresponding red, green, and blue component values of the pixel.
   When Red=Green=Blue, a pixel has a hue of brightness without human perception of color. Some display systems with RGB representation assign integers up to 255 to each components of Red, Green or Blue. The color difference of a pixel in the left and right perspective images is Δ_{x,y}=R_{x,y}−L_{x,y}. This color difference Δ_{x,y} is intended to be hidden by the use of a transformation image C_{x,y} so that the superposition of left-perspective, right-perspective, and transformation images result only left-perspective image is remained plus a residual hue. Here, the representation of a hue image can be defined by

H_{x,y}=max(0, Δ_{x,y}(Red), Δ_{x,y}(Green), Δ_{x,y}(Blue)). (3)

A function F_{x,y} can be defined by

F_{x,y}=(H_{x,y}−Δ_{x,y}(Red), H_{x,y}−Δ_{x,y}(Green), H_{x,y}−Δ_{x,y}(Blue)). (4)

The transformation image C_{x,y} can be defined by the function F_{x,y} as follows:

C_{x,y}=F_{x,y}=(H_{x,y}−Δ_{x,y}(Red), H_{x,y}−Δ_{x,y}(Green), H_{x,y}−Δ_{x,y}(Blue). (5)

Alternatively, the transformation image can be defined by the function F_{x,y} along with a smoothing function as follows:

C_{x,y}=F_{x,y}+S(H_{x,y}) (6)
where S(H_{x,y}) is a filter function that operates to smooth the hue in the image defined by F_{x,y} image.
   In this manner, the left-perspective image L_{x,y} becomes the dominant perceived image by viewers who do not have shutter glasses synchronized to block out the transformation image C_{x,y}. Such operations are also useful for reducing the discomfort for viewers that are wearing shutter glasses that have been disabled (i.e., always ON or open for both the left and right shutters) when viewing the sequence of image triplets on the display apparatus 14.

Note that the image triplets as described herein can be generated externally and loaded into the image generation apparatus 12 via optical drive 22 or other suitable means. This configuration is generally suitable for processing video data files that represent a sequence of image triplets as described herein. Alternatively, the transformation image of the image triplets as described herein can be generated by the image generation apparatus 12 during processing (e.g., decoding or rendering) of a stereoscopic image sequence as needed. This configuration is generally suitable for processing video data files that represent a sequence of stereoscopic images that lack the transformation image corresponding thereto. This configuration is also generally suitable for processing three-dimensional graphics data files as described herein as the stereoscopic images are typically rendered in real time in accordance with the user-selected viewpoints. In yet another alternative embodiment, the transformation image of the image triplets as described herein can be generated by the display apparatus 14 during the display of a stereoscopic image sequence as needed. In yet another alternative embodiment, the transformation image of the image triplets as described herein can be generated by the image generation apparatus 12 prior to output of the stereoscopic image sequence for display, and persistently stored in non-volatile data storage 22 for subsequent use as needed. This configuration is generally suitable for processing video data files that represent a sequence of stereoscopic images that lack the transformation image corresponding thereto. Alternatively, the transformation image of the image triplets can be stored, generated or otherwise provided at other points in the processing and display of a stereoscopic image sequence.

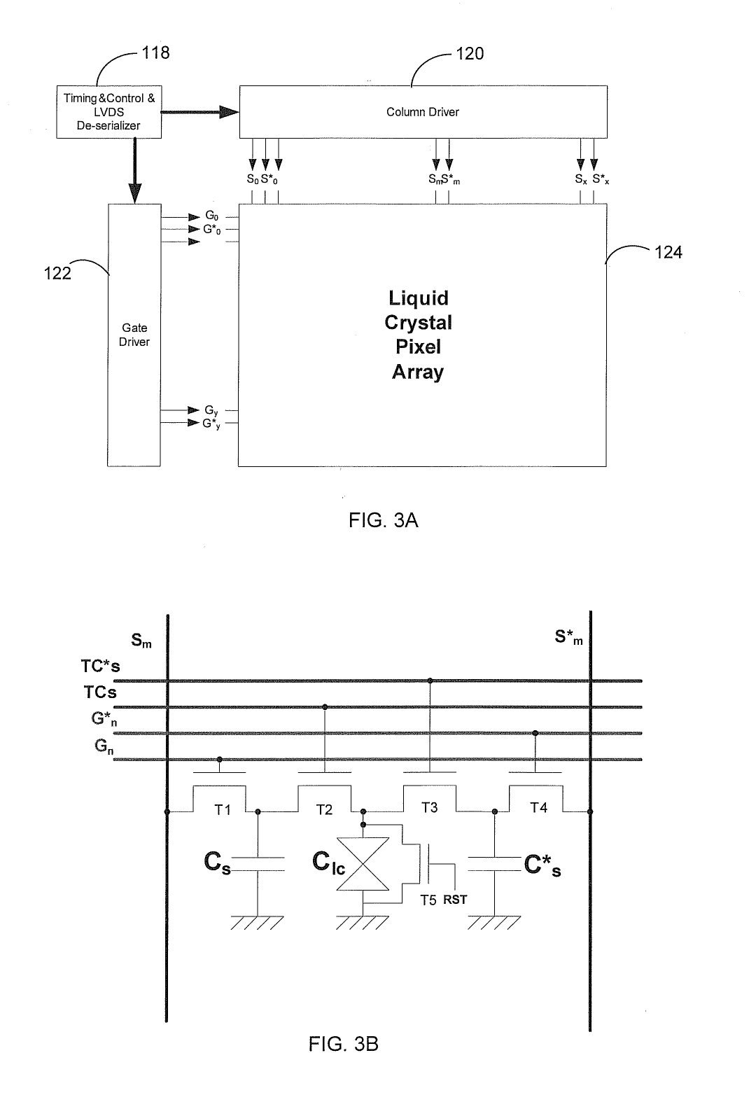

FIGS. 3A and 3B illustrate an exemplary embodiment of an active matrix liquid crystal display architecture that can be used to realize the display apparatus 14 as described herein. Such architecture is suitable for transmissive-type LCD panels as well as LCD front-projection and rear-projection displays. Similar architectures are suitable for LCOS projection displays and SXRD projection displays as well as OLED displays. The architecture includes an interface block 118 that receives the frame-sequential digital video signal communicated from the image generation apparatus 12. In the preferred embodiment, the frame-sequential digital video signal is communicated from the image generation apparatus 12 to the interface block 118 over a serial communication channel that employs low-voltage differential signaling (LVDS). In this configuration, the interface block 118 includes LVDS interface circuitry and a de-serializer. The interface block 118 recovers the red, green and blue pixel data encoded in the frame-sequential digital video signal, possibly re-scales such pixel data, and forwards the red, green and blue pixel data to a column driver 120 as is well known. It also includes a timing signal generator and control circuit that generates a pixel clock as well as other timing control signals that are supplied to the column driver 120 and a gate driver 122 as is well known.

The gate driver 122 and the column driver 120 cooperate to load the active pixels of the array 124 with the appropriate analog voltage levels (which correspond to the red, green and blue pixel data supplied to the column driver 120) and hold such voltage levels for a predetermined time period (which corresponds to the duration of the active frame). To perform this function, the column driver 120 preferably includes shift registers and digital-to-analog converters that generate analog voltage levels which correspond to the red, green and blue pixel data supplied thereto as well as source drivers that supply such analog voltage levels to the respective source lines S₀, S*₀, S₁, S*₁, . . . Sₓ, S*ₓ of the pixel array 116. The polarity of the analog voltage levels preferably conform to an inversion scheme (e.g., pixel dot inversion, sub-pixel dot inversion) in order to prevent polarization of the liquid crystal material and reduce flicker. The gate driver 122 includes addressing logic and drivers that selectively activate and deactivate the gate lines G₀, G*₀, G₁, G*₁ . . . G_{y}, G*_{y} of the pixel array 116. When the gate driver 122 activates a gate line (for example, gate line G₀) for a given row of the array 116, the voltage levels supplied by the column driver 120 on the source lines S₀, S₁, . . . Sₓ of the array 116 are loaded into the pixels of the given row (e.g., the row corresponding to gate line G₀).

FIG. 3B illustrates an active pixel structure suitable for the architecture of FIG. 3B. In this structure, the pixel has two storage capacitors Cₛ and C*ₛ, two source line Sₘ and S*ₘ (which are coupled to the pixels of the column m of the array), and two gate lines Gₙ and G*ₙ (which are coupled to the pixels of the row n of the array). Two control lines TCs and TC*s are coupled to all of the pixels of the array. The source line Sₘ is selectively coupled to the first plate of storage capacitor Cₛ by the current path of a thin-film transistor T1. The source line S*ₘ is also selectively coupled to the first plate of storage capacitor C*ₛ by the current path of a thin-film transistor T4. The first plate of the storage capacitor Cₛ is selectively coupled to the bottom electrode of the liquid crystal cell (denoted by its parasitic capacitance C_{lc}) by the current path of a thin-film transistor T2. The first plate of the storage capacitor C*ₛ is selectively coupled to the bottom electrode of the liquid crystal cell by the current path of a thin-film transistor T3. The top electrode of the liquid crystal cell is coupled to a reference voltage (e.g., ground potential as shown). The second plate of the storage capacitor Cₛ and the second plate for the storage capacitor C*ₛ are also coupled to the reference voltage (e.g., ground potential as shown). The gate line Gₙ is coupled to the control electrode (gate) of the transistor T1. The gate line G*ₙ is coupled to the control electrode (gate) of the transistor T4. The control line TCs is coupled to the control electrode (gate) of the transistor T2. The control line TC*s is coupled to the control electrode (gate) of the transistor T3. A reset line RST is coupled to the control electrode (gate) of a thin-film transistor T5, which is connected across the bottom and top electrode of the liquid crystal cell. The voltage potential applied to the bottom electrode of the liquid crystal cell provides a voltage difference between the bottom and top pixel electrodes, which controls the orientation of the LC material therebetween. Such control over the orientation of the LC material of the cell provides control over the polarization state of the light emitted therefrom and is used as part of a light valve to control the gray level light intensity for the pixel.

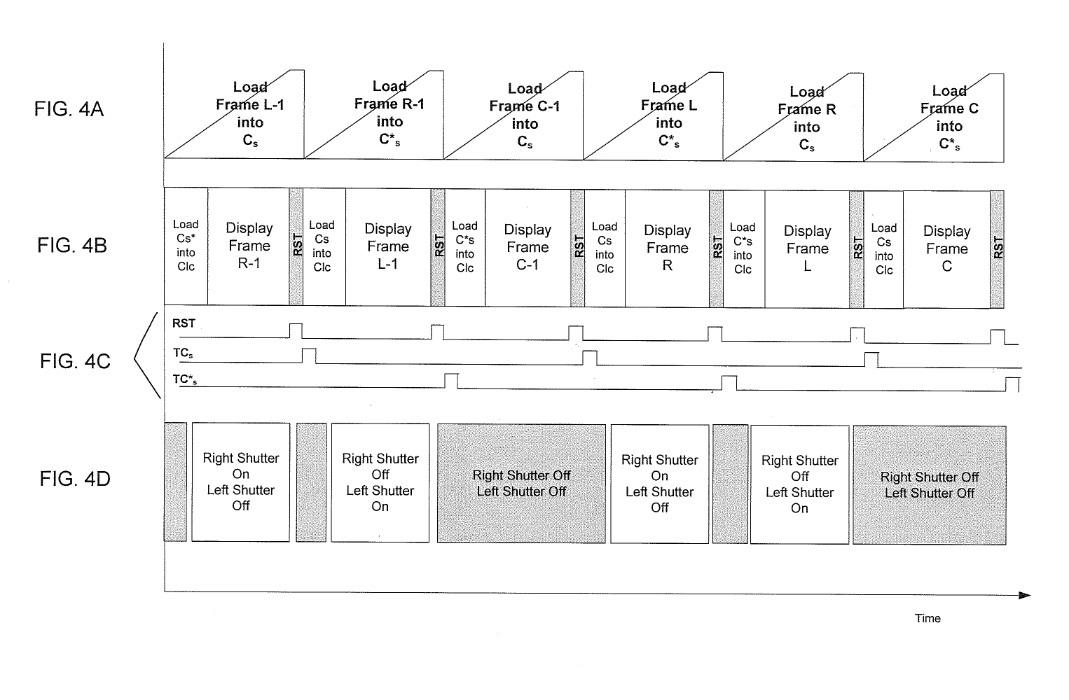

In the architecture of FIGS. 3A and 3B, interleaved pixel loading and display operations are performed over the image triplets encoded by the frame-sequential digital video signal. In an exemplary embodiment illustrated in FIGS. 4A and 4B, the image triplets encoded by the frame-sequential digital video signal include a sequence of a right-perspective image followed by a left-perspective image followed by a transformation image. During the respective display period for each image (or frame) of this sequence, the storage capacitors Cs and C*s of the pixels of the array are loaded in an interleaved manner with analog voltage potential signals corresponding to the image for the next display period (FIG. 4A) while displaying the image for the current display period (FIG. 4B). Such image display operations include a reset operation followed by a charge transfer operation and hold operation as shown in FIG. 4B.

During the reset operation (which is labeled RST in FIG. 4B), the gate driver 122 activates the reset line RST as shown in FIG. 4C, which causes the current path of transistor T5 to be activated and thus connects together the bottom and top electrode of the pixel. This clears any charge stored by the pixel and thus applies a null voltage signal to the liquid crystal cell, thereby producing a “dark” pixel. After the reset operation is complete, the gate driver 122 de-activates the reset line RST as shown in FIG. 4C, which causes the current path of transistor T5 to be de-activated.

The charge transfer operations (labeled as load operations in FIG. 4B) transfer charge stored on one of the storage capacitors Cs and C*s to the liquid crystal cell (denoted by its parasitic capacitance C_{lc}) of the pixel. Such charge transfer operations are performed in an interleaved manner over the image triplets of the sequence. More specifically, the display periods of the image triplets are logically partitioned into two interleaved groups, which can be defined as “even” group display periods (display frame L-1, display frame R, display frame C) interleaved with “odd” group display periods (display frame R-1, display frame C-1, display frame L).

During the “even” group display periods, the gate driver 122 activates the line TCs as shown in FIG. 4C, which transfers charge from the storage capacitor Cs to the liquid crystal cell via activation of transistor T2. The gate driver 122 then de-activates the line TCs as shown in FIG. 4C, which causes the current path of transistor T2 to be de-activated and thus isolates the liquid crystal cell from the storage capacitor Cs. In this state, which is referred to as the holding condition or hold state, the liquid crystal cell C_{lc} stores charge that maintains the desired voltage potential signal across the liquid crystal cell for the given display period. This holding condition continues for the duration of the given display period and is terminated by the next successive reset operation.

During the “odd” group display periods, the gate driver 122 activates the line TC*s as shown in FIG. 4C, which transfers charge from the storage capacitor C*s to the liquid crystal cell via activation of transistor T3. The gate driver 122 then de-activates the line TC*s as shown in FIG. 4C, which causes the current path of transistor T3 to be de-activated and thus isolates the liquid crystal cell from the storage capacitor C*s. In this hold state, the liquid crystal cell C_{lc} stores charge that maintains the desired voltage potential signal across the liquid crystal cell for the given display period. This holding condition continues for the duration of the given display period and is terminated by the next successive reset operation.

Note that the interleaved charge transfer operations from the storage capacitors Cs and C*s over the display periods of the sequence of image triplets (FIG. 4B) is opposite to the interleaved loading of the storage capacitors Cs and C*s over the sequence of image triplets (FIG. 4A). In this manner, as charge is being transferred from the storage capacitor Cs over the display periods of the sequence of image triplets, the storage capacitors C*s of the pixels of the array are being loaded for the next display period. Similarly, as charge is being transferred from the storage capacitor C*s over the display periods of the sequence of image triplets, the storage capacitors Cs of the pixels of the array are being loaded for the next display period. Such display operations result in a sequence of display periods for the right-perspective image followed by the left-perspective image followed by the transformation image. During the right-perspective image display period, the pixels of the array display the right-perspective image. During the left-perspective image display period, the pixels of the array display the left-perspective image. During the transformation image display period, the pixels of the array display the transformation image.

FIG. 4D illustrate the temporal relationship of the interleaved pixel load/hold operations and display operations of FIGS. 4A-4C with the operation of shutter glasses, respectively. The synchronization signal is synchronized to the display periods of the image triplets and is adapted to control the shutter glasses 28 to turn ON and OFF the left and right shutters of the glasses 28 as shown in FIG. 4D. More specifically, during the right-perspective display period whereby the right-perspective image is displayed, the shutter glasses 28 are controlled to turn ON (i.e., open) the right shutter and turn OFF (i.e., close) the left shutter. During the left-perspective display period whereby the left-perspective image is displayed, the shutter glasses 28 are controlled to turn OFF (i.e., closed) the right shutter and turn ON (i.e., open) the left shutter. During the transformation image display period whereby the transformation image is displayed, the shutter glasses 28 are controlled to turn OFF (i.e., closed) both the left and right shutters.

In this manner, the viewer(s) that wear the shutter glasses 28 view the right-perspective images only in his/her right eye and view the left-perspective image only in his/her left eye to provide the desired stereoscopic effect. The viewer(s) that wear the shutter glasses 28 are also blocked from viewing the transformation images and thus their stereoscopic viewing experience is not significantly degraded by the transformation images.

For the viewers that do not wear the shutter glasses (or whose shutter glasses have been disabled), the transformation image is viewed by such users in combination with the left and right perspective images. However, the transformation image is adapted to reduce discomfort when viewing stereoscopic image sequence without shutter glasses.

In another aspect of the present invention, the image sequences stored and/or generated by the image generation apparatus 12 include a sequence of image triplets that include a right-perspective image, a left-perspective image, and a cloaking image. The sequence of image triplets are displayed on the display apparatus 14 in a frame sequential manner, for example as depicted in the sequence of FIG. 2 which includes frame R-1 (right perspective frame) followed by frame L-1 (left-perspective frame) followed by frame C-1 (cloaking frame). The synchronization signal is synchronized to the display periods of the image triplets and is adapted to control the shutter glasses 28 to turn ON and OFF the left and right shutters of the glasses 28 as shown in FIG. 2. More specifically, when the right-perspective image is displayed by the display apparatus 14, the shutter glasses 28 are controlled to turn ON (i.e., open) the right shutter and turn OFF (i.e., close) the left shutter. When the left-perspective image is displayed by the display apparatus 14, the shutter glasses 28 are controlled to turn OFF (i.e., closed) the right shutter and turn ON (i.e., open) the left shutter. When the cloaking image is displayed by the display apparatus 14, the shutter glasses 28 are controlled to turn OFF (i.e., closed) both the left and right shutters. In this manner, the viewer(s) (one shown as viewer A) that wear the shutter glasses 28 view the right-perspective images only in his/her right eye and view the left-perspective image only in his/her left eye to provide the desired stereoscopic effect. The viewer(s) that wear the shutter glasses 28 are also blocked from viewing the cloaking images and thus their stereoscopic viewing experience is not significantly degraded by the cloaking images.

The cloaking images are viewed by viewers that do not wear shutter glasses (e.g., one shown as viewer B in FIG. 1) and are used in combination with the left and right perspective images to synthesize a scene that hides or obfuscates the information contained in the left and right perspective images when viewed by users who do not have shutter glasses synchronized to the image triplet sequence display for blocking the cloaking image. In contrast, the users that do have shutter glasses synchronized to the image triplet sequence display for blocking the cloaking image can view the left and right perspective images of the image triplet sequence in private. It is contemplated that the synchronization signal can be communicated to the shutter glasses over a secured communication channel to authorized shutter glasses in order to limit viewing of the private content to only users that wear such authorized shutter glasses.

In the preferred embodiment of the invention, the cloaking image of a given image triplet is derived by applying a predetermined transformation operation to the color values of corresponding pixels of the left-perspective and right-perspective images of the given image triplet on a pixel-by-pixel basis. Alternatively, the transformation operation can be performed over corresponding neighboring pixel groups, e.g., neighboring 2×2 pixels, neighboring 3×3 pixels, neighboring 4×4 pixels, etc. For example, the cloaking image can be defined such that it in combination with the left and right perspective images synthesizes an all white image. Such a cloaking image CL_{x,y} can be derived from the pixels of the left and right perspective images (L_{x,y} and R_{x,y}) on a pixel-by-pixel basis as follows:

CL_{x,y}=(255,255,255)−R_{x,y}−L_{x,y} (7)
where (255,255,255) represents the red, green and blue component values of a white pixel.

Alternatively, the cloaking image CL_{x,y} can be generated to produce a composition image other than all white that hides or obfuscates the information contained in the left and right perspective images when viewed by users who do not have shutter glasses synchronized to the image triplet sequence display for blocking the cloaking image.

It is also contemplated that the cloaking image can be added to a non-stereoscopic image sequence to provide privacy. In such a system, the image sequences stored and/or generated by the image generation apparatus 12 include a sequence of image pairs that include a primary image and a cloaking image. The sequence of image pairs are displayed on the display apparatus 14 in a frame sequential manner, for example a sequence that includes the primary image followed by the cloaking image. The synchronization signal is synchronized to the display periods of the image pairs and is adapted to control the shutter glasses 28 to selectively turn ON and OFF the left and right shutters of the glasses 28. More specifically, when the primary image is displayed by the display apparatus 14, the shutter glasses 28 are controlled to turn ON (i.e., open) both the left and right shutters. When the cloaking image is displayed by the display apparatus 14, the shutter glasses 28 are controlled to turn OFF (i.e., closed) both the left and right shutters. In this manner, the viewer(s) (one shown as viewer A) that wear the shutter glasses 28 view the primary images of the image sequence, and are blocked from viewing the cloaking images of the image sequence.

The cloaking images are viewed by viewers that do not wear shutter glasses (e.g., one shown as viewer B in FIG. 1) and are used in combination with the primary images to synthesize a scene that hides or obfuscates the information contained in the primary images when viewed by users who do not have shutter glasses synchronized to the image sequence display for blocking the cloaking image. In contrast, the users that do have shutter glasses synchronized to the image sequence display for blocking the cloaking image can view the primary images of the image sequence in private.

In the preferred embodiment of the invention, the cloaking image of a given image pair is derived by applying a predetermined transformation operation to the color values of the corresponding pixels of the primary image of the given image pair on a pixel-by-pixel basis. Alternatively, the transformation operation can be performed over corresponding neighboring pixel groups, e.g., neighboring 2×2 pixels, neighboring 3×3 pixels, neighboring 4×4 pixels, etc. For example, the cloaking image can be defined such that it in combination with the primary image synthesizes an all white image. Such a cloaking image CL_{x,y} can be derived from the color values of the pixels of the primary image (P_{x,y}) on a pixel-by-pixel basis as follows:

CL_{x,y}=(255,255,255)−P_{x,y} (8)

where P_{x,y}=(PRed(x,y),PGreen(x,y),PBlue(x,y)), (9)
x,y represent a pixel of the image,
PRed, PGreen, and PBlue represent the corresponding red, green and blue component values of the color of the given pixel; and
(255,255,255) represents the red, green and blue component values of a white pixel.

Alternatively, the cloaking image CL_{x,y} can be generated to produce a composition image other than all white that hides or obfuscates the information contained in the primary images when viewed by users who do not have shutter glasses synchronized to the image sequence display for blocking the cloaking image.

Note that the active pixel structure of FIGS. 3A and 3B as well as the interleaved pixel load/hold operations and display operations of FIGS. 4A-4C and shutter glass operations of FIG. 4D can be adapted to support the display of cloaking images as part of a frame sequential stereoscopic image sequence (or a frame sequential non-stereoscopic image sequence) for privacy purposes as described above.

There have been described and illustrated herein several embodiments of image generation and display systems and methodologies and mechanisms used therein. While particular embodiments of the invention have been described, it is not intended that the invention be limited thereto, as it is intended that the invention be as broad in scope as the art will allow and that the specification be read likewise. Thus, while particular system architectures and particular pixel structures have been disclosed, it will be appreciated that other system architectures and pixel structures can be used as well. In addition, while particular signaling schemes and control schemes have been disclosed, it will be understood that other signaling schemes and control schemes can be used. For example, it is contemplated that the ordering of the images of the frame sequential image sequence processed and displayed as described herein can be modified as needed. In another example, the front end image generation apparatus as described above can generate and process a frame-sequential stereo video signal. Such processing is advantageous because it can operate on traditional (non-stereo) frame-sequential video signals to provide for display of such traditional frame-sequential video signals (without the use of shutter glasses). One skilled in the art will appreciate that the interface block of the display apparatus can readily be adapted to accommodate other signal formats, including, but not limited to, a dual-channel signal format (i.e., the left and right perspective images communicated in physically separate channels), a single-channel row interleaved signal format (i.e., the left and right perspective images are multiplexed together on alternating rows in each image frame), a single-channel over-under signal format (i.e., the left and right perspective images are added to the top and bottom halves of each image frame), a single-channel side-by-side signal format (i.e., the left and right perspective images are added to the left and rights sides of each image frame), a single-channel column interleaved signal format (i.e., the left and right perspective images are multiplexed together on alternating columns of each image frame), and single-channel dual-frame color multiplexed format (i.e., the left and right perspective images are encoded in two sequential output frames by color multiplexing). It will therefore be appreciated by those skilled in the art that yet other modifications could be made to the provided invention without deviating from its spirit and scope as claimed.

What is claimed is:

1. A display method comprising:
generating at least one signal representing a sequence of image triplets including a left perspective image, a right perspective image and a transformation image, said transformation image adapted to reduce discomfort when viewing the sequence of image triplets displayed on a display apparatus in a frame-sequential manner;
processing said at least one signal for displaying said sequence of image triplets in a frame-sequential manner on the display apparatus; and
communicating a synchronization signal to shutter glasses for blocking the viewing of said transformation image of said sequence of image triplets.

2. A display method according to claim 1, wherein:
said transformation image for a given image triplet is derived from one of said right-perspective image and said left-perspective image of said given image triplet.

3. A display method according to claim 2, wherein:
said transformation image comprises a negative or complement color image of one of said right-perspective image and said left-perspective image of said given image triplet.

4. A display method according to claim 1, wherein:
the shutter glasses have a left shutter overlying the left eye of a user and a right shutter overlying the right eye of the user, and the synchronization signal is used to open the left shutter and close the right shutter during display of the left-perspective image on the display apparatus, to open the right shutter and close the left shutter during display of the right-perspective image on the display apparatus, and to close the left and right shutter during display of the transformation image on the display apparatus.

5. A display method according to claim 1, wherein:
said sequence of image triplets are stored on an optical disc for loading into an image generation apparatus for display.

6. A display method according to claim 1, further comprising:
generating said transformation image of said sequence of image triplets in conjunction with processing of a stereoscopic image sequence.

7. A display method according to claim 1, further comprising:
generating said transformation image of said sequence of image triplets in conjunction with processing of three-dimensional graphics data to generate a stereoscopic image sequence.

8. A display method according to claim 1, wherein:
said display apparatus employs an array of active pixels that are adapted to perform interleaved pixel loading and display operations on an image-by-image basis over said image triplets.

9. A display apparatus comprising:
means for generating at least one signal representing a sequence of image triplets including a left perspective image, a right perspective image and a transformation image, said transformation image adapted to reduce discomfort when viewing the sequence of image triplets displayed on a display apparatus in a frame-sequential manner;
means for processing said at least one signal to display said sequence of image triplets in a frame-sequential manner; and
means for communicating a synchronization signal to shutter glasses for blocking the viewing of said transformation image of said sequence of image triplets.

10. A display apparatus according to claim 9, wherein:
said transformation image for a given image triplet is derived from one of said right-perspective image and said left-perspective image of said given image triplet.

11. A display apparatus according to claim 10, wherein:
said transformation image comprises a negative or complement color image of one of said right-perspective image and said left-perspective image of said given image triplet.

12. A display apparatus according to claim 9, wherein:
the shutter glasses have a left shutter overlying the left eye of a user and a right shutter overlying the right eye of the user, and the synchronization signal is used to open the left shutter and close the right shutter during display of the left-perspective image, to open the right shutter and close the left shutter during display of the right-perspective image, and to close the left and right shutter during display of the transformation image.

13. A display apparatus according to claim 9, wherein:
said means for generating said at least one signal comprises an optical disc drive for loading an optical disc that stores said at least one signal.

14. A display apparatus according to claim 9, wherein:
said means for generating said at least one signal includes means for generating said transformation image of said sequence of image triplets in conjunction with processing of a stereoscopic image sequence.

15. A display apparatus according to claim 9, wherein:
said means for generating said at least one signal includes means for generating said transformation image of said sequence of image triplets in conjunction with processing of three-dimensional graphics data to generate a stereoscopic image sequence.

16. A display apparatus according to claim 9, further comprising:
an array of active pixels that are adapted to perform interleaved pixel loading and display operations on an image-by-image basis over said image triplets.

17. A display method comprising:
generating at least one signal representing a sequence of image n-tuples (where n=2 or 3) including a cloaking image, said cloaking image adapted to synthesize a scene that hides or obfuscates the information contained in other image(s) of said image n-tuple when viewing the sequence of image n-tuples displayed on a display apparatus in frame-sequential manner;
processing said at least one signal for displaying said sequence of image n-tuples in a frame-sequential manner on a display apparatus; and
communicating a synchronization signal to shutter glasses for blocking the viewing of said cloaking image of said sequence of image n-tuples.

18. A display method according to claim 17, wherein:
said cloaking image of a given image n-tuple is derived by applying a predetermined transformation operation to the color values of the corresponding pixels of the other image(s) of the given n-tuple.

19. A display method according to claim 18, wherein:
the predetermined transformation operation is carried out on a pixel-by-pixel basis over the other image(s) of the given n-tuple.

20. A display method according to claim 17, wherein:
the shutter glasses have a left shutter overlying the left eye of a user and a right shutter overlying the right eye of the user, and the synchronization signal is used to close the left and right shutter during display of the cloaking image on the display apparatus.

21. A display method according to claim 17, wherein:
said sequence of image n-tuples are stored on an optical disc for loading into an image generation apparatus for display.

22. A display method according to claim 17, further comprising:
generating said cloaking image of said sequence of image n-tuples in conjunction with processing of an image sequence.

23. A display method according to claim 17, further comprising:
generating said cloaking image of said sequence of n-tuples in conjunction with processing of three-dimensional graphics data to generate a stereoscopic image sequence.

24. A display method according to claim 17, wherein:
said display apparatus employs an array of active pixels that are adapted to perform interleaved pixel loading and display operations on an image-by-image basis over said image n-tuples.

25. A display method according to claim 17, further comprising:
communicating said synchronization signal to said shutter glasses over a secure communication channel to provide authorized viewing of said sequence of image n-tuples.

26. A display apparatus comprising:
means for generating at least one signal representing a sequence of image n-tuples (where n=2 or 3) including a cloaking image, said cloaking image adapted to synthesize a scene that hides or obfuscates the information contained in other image(s) of said image n-tuple when viewing the sequence of image n-tuples displayed on a display apparatus in frame-sequential manner;
means for processing said at least one signal to display said sequence of image n-tuples in a frame-sequential manner; and
means for communicating a synchronization signal to shutter glasses for blocking the viewing of said cloaking image of said sequence of image n-tuples.

27. A display apparatus according to claim 26, wherein:
said cloaking image of a given image n-tuple is derived by applying a predetermined transformation operation to the color values of the corresponding pixels of the other image(s) of the given n-tuple.

28. A display apparatus according to claim 27, wherein:
the predetermined transformation operation is carried out on a pixel-by-pixel basis over the other image(s) of the given n-tuple.

29. A display apparatus according to claim 26, wherein:
the shutter glasses have a left shutter overlying the left eye of a user and a right shutter overlying the right eye of the user, and the synchronization signal is used to close the left and right shutter during display of the cloaking image.

30. A display apparatus according to claim 26, wherein:
said means for generating said at least one signal comprises an optical disc drive for loading an optical disc that stores said at least one signal.

31. A display apparatus according to claim 26, wherein:
said means for generating said at least one signal comprises means for generating said cloaking image of said sequence of image n-tuples in conjunction with processing of an image sequence.

32. A display apparatus according to claim 26, wherein:
said means for generating said at least one signal comprises means for generating said cloaking image of said sequence of n-tuples in conjunction with processing of three-dimensional graphics data to generate a stereoscopic image sequence.

33. A display apparatus according to claim 26, further comprising:
an array of active pixels that are adapted to perform interleaved pixel loading and display operations on an image-by-image basis over said image n-tuples.

34. A display apparatus according to claim 26, further comprising: means for communicating said synchronization signal to said shutter glasses over a secure communication channel to provide authorized viewing of said sequence of image n-tuples.
